(19) United States
(12) Patent Application Publication
(10) Pub. No.: US 2002/0084910 A1
(43) Pub. Date: Jul. 4, 2002

(54) Automotive multiple media system

(76) Inventors: Kenneth Owens, Lake Mary, FL (US); Nicholas Soudas, Long Wood, FL (US); Matthew Spiro, Lake Mary, FL (US)

Correspondence Address: Peter L. Berger, LEVISOHN, LERNER, BERGER & LANGSAM, Suite 2400, 757 Third Avenue, New York, NY, 10017, US

(21) Appl. No.: 09/752,269

(22) Filed: Dec. 29, 2000

(51) Int. Cl. G05B 19/02

(52) U.S. Cl. 340/825.24; 340/825.69

(57) ABSTRACT

A head unit in an automotive audio system has a master microprocessor connected to a bus for serial additional of modules for expanding the system. The bus is continuous through each module, and provides both inputs and outputs to and from the head unit. Modules may include an RF remote control module, an RF headphones module, and an A/V source selector which permits rear seat occupants to choose and control a video source such as a VCR or a game.

The invention relates to a multiple media system which permits occupants in different parts of a vehicle to enjoy different programs. More particularly, it relates to a system having a bus extending from an in-dash head unit for the serial connection of modules for additional inputs, outputs, and control media.

### BACKGROUND OF THE INVENTION

The term head unit general refers to the central unit in an automotive audio system, which typically includes a radio tuner and a cassette tape player and/or a CD player. This makes a variety of programming available for the vehicle occupants. However all occupants must listen to the same music or other program even where front and rear speakers are provided.

U.S. Pat. No. 5,661,811 to Huemann et al. describes an automotive audio system which includes a rear control console for plugging in headphones with separate volume controls, and for disconnecting the rear speakers, so that the rear occupants can listen to music or other fare without interfering with the output of the front speakers. Controls in the rear are provided to select a medium other than that being played in the front. Thus, if the driver is listening to the radio, the rear selection may be any available media, i.e., the radio, a cassette tape, or a CD. If the media choice is other than the one selected by the driver, then the rear controls can be used to seek other stations or advance to another selection.

Huemann employs a standard audio processor which selects one of the inputs; controls loudness, bass, and other functions, and supplies left and right output channels for both the front and rear. The front channels are fed through a front amplifier to the front speakers. The rear channels as well as the outputs of the tuner, cassette player, and CD player are fed to a multiplexer or switch whose output is fed to a rear amplifier then through a rear switch to either the rear speakers or the headphones. A microprocessor, subject to control signals from both the front seat control and the rear seat control, selects the media for the front and rear, and directs the rear output to the speakers or headphones.

The system permits some control of media selection from the rear, subject to dominance of the front control when there is a conflict. However the system is fully integrated and is thus confirmed to the originally supplied media without the possibility to expansion. There is no provision for adding media, in particular audio/video sources, which can be controlled from the front and rear.

### SUMMARY OF THE INVENTION

The invention relates to an expandable system having a bus which permits the serial additional of modules for additional inputs and outputs, the bus running through each module. The head unit has circuitry configured to recognize when these inputs and outputs have been added to the system, as well as a display and manual controls which allow the vehicle driver at least some control over the entire system.

The head unit has conventional features such as a tuner and CD player, as well as auxiliary inputs for adding a cassette player and a CD changer. The bus is a bundle of parallel lines including power, ground, audio in, audio out, and data read/write lines. The bus begins with a cable at the back of the head unit, which cable is terminated at a plug. Modules for RF remote control, RF headphones, and an audio/video selection may be added serially, in any order. The head unit is fully operative regardless of how many modules have been added, including none.

A consumer who wants a large system without a large initial investment may thus begin with just the head unit, which may be connected to the vehicle's OEM speakers. He may then buy additional modules as desired for RF remote control, headphones, and an A/V system.

The A/V system begins with an A/V interface module having plugs for serial incorporation in the bus. The interface module in turn is connected to an A/V source selector module which serves as a switching unit between various A/V inputs and a monitor, subject to control at the head unit or an RF remote control unit.

The fully expanded system offers enormous versatility for a traveling family. The front seat occupants may be listening to the radio or a CD, while the back seat occupants can play a video game or watch a movie, subject to their own control. However the front seat occupants also have the option of listening to the audio output from A/V sources, or of turning off the A/V sound to convey an oral message. The rear seat occupants can also listen to a CD of their own choice, or the radio, with the proviso that they cannot override the driver's choice.

Additional advantages will be apparent from the drawings and description which follow.

### BRIEF DESCRIPTION OF THE DRAWING

FIG. 1 is a schematic of the multiple media system according to the invention;

FIG. 2 is a diagram of the lines in the bus;

FIG. 3 shows some of the bus connections to the RF remote module;

FIG. 4 shows some of the bus connections to the headphones module;

FIG. 5 shows some of the bus connections to the A/V interface module;

FIG. 6 is a schematic of the main head unit plug and the speakers;

FIG. 7 is a schematic perspective of the of the A/V interface module, source selector module, and adaptor harness therebetween;

FIG. 8 is a rear view of the source selector module;

FIG. 9 is a schematic of the integrated circuit chips in the head unit;

FIG. 10 is a plan view of the face plate on the head unit;

FIG. 11 is a plan view of the infrared remote control unit;

FIG. 12 is a plan view of the RF remote control unit; and

FIG. 13 is a perspective view of the RF headphones.

### DETAILED DESCRIPTION OF THE PREFERRED EMBODIMENT

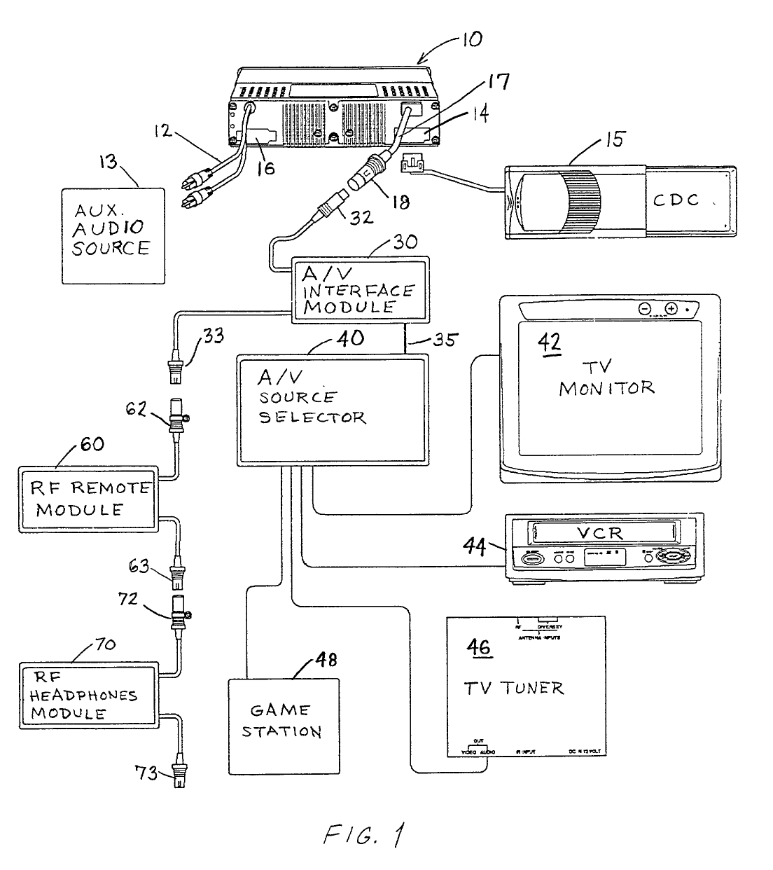

FIG. 1 shows the back of the head unit 10, which is configured to fit in the dashboard of a car as the replacement for an OEM head unit. Auxiliary plugs 12 are conventional RCA plugs provided for connection to an auxiliary audio source 13 such as a cassette tape deck or an MP3 player. A CDC port 14 receives the plug of a CDC (compact disc changer) 15 which may be added to supplement the CD player in the head unit 10. The main port 16 receives the main plug 50 (FIG. 6) which provides (inter alia) the main power and ground connections and the speaker connections. The bus cable 17 carries all the lines for connecting to peripheral system modules which can be serially connected beginning at plug 18. These include but are not limited to an A/V interface module 30 having a first bus plug 32 and a second bus plug 33, an RF remote module 60 having a first bus plug 62 and a second bus plug 63, and an RF headphones module 70 having a first bus plug 72 and a second bus plug 73. All plugs are 13 pin plugs, the first plugs 32, 62, 72 being male and the second plugs 33, 63, 73 as well as the main bus plug 18 being female. Either one or all of the modules 30, 60, 70 may be installed, and they may be installed in any order. The bus is continuous through all modules.

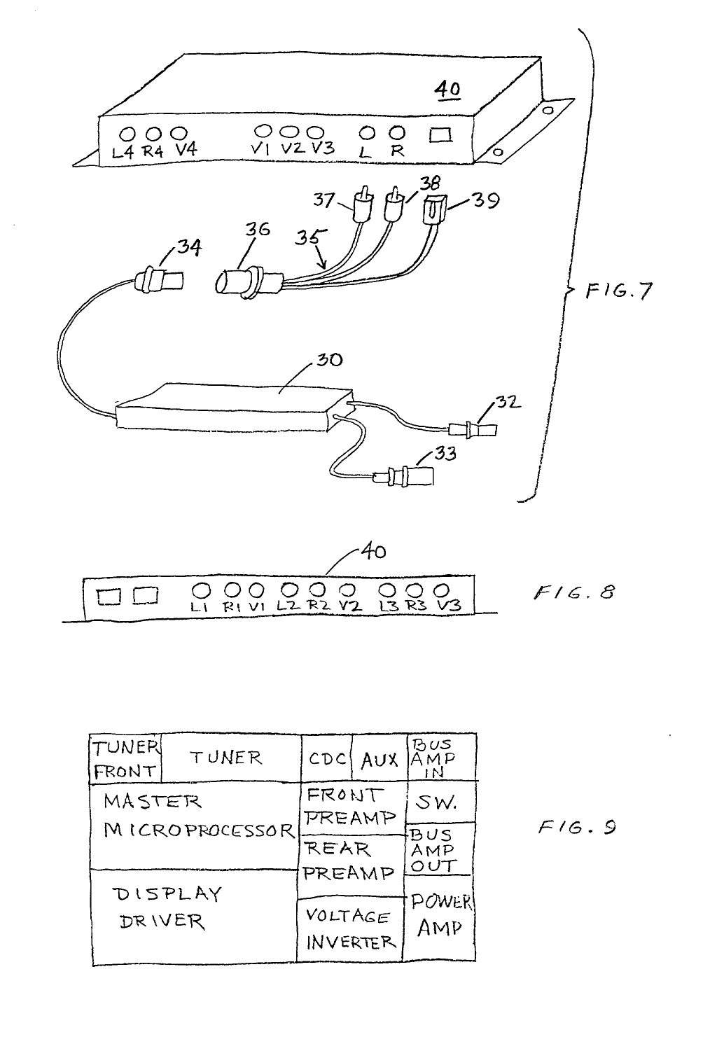

The A/V interface module 30 is connected to a source selector module 40 by an adaptor harness 35 which will be further described in conjunction with FIG. 7. The source selector 40 provides a switched connection between the TV monitor 42 and an A/V source such as VCR 44, tuner 46, and game station 48. The A/V sources supplied with twelve volt power independently of the bus.

Referring to FIG. 2, the bus includes an accessory twelve volt line B1 which is a switched battery source, a constant twelve volt line B2 which is an unswitched battery source, and a chassis ground line B3 which is the power ground. Lines B4 and B5 are the right and left audio signal “out” lines for the wireless headphones, and line B6 is the corresponding ground. Lines B7 and B8 and the right and left audio signal “in” lines from the A/V units, and line B9 is the corresponding ground. B10 is another chassis ground and B11 has no connection at this time (but allows for future addition). B12 is the data ground and B13 is the data read/write line which carries virtually all information not otherwise accounted for to and from the modules. This includes polling information, control commands from the head unit to the modules, and commands from the modules to the head unit. Each one of the peripheral modules is a digital data source which is assigned a time slot for communication with the master microprocessor in the head unit.

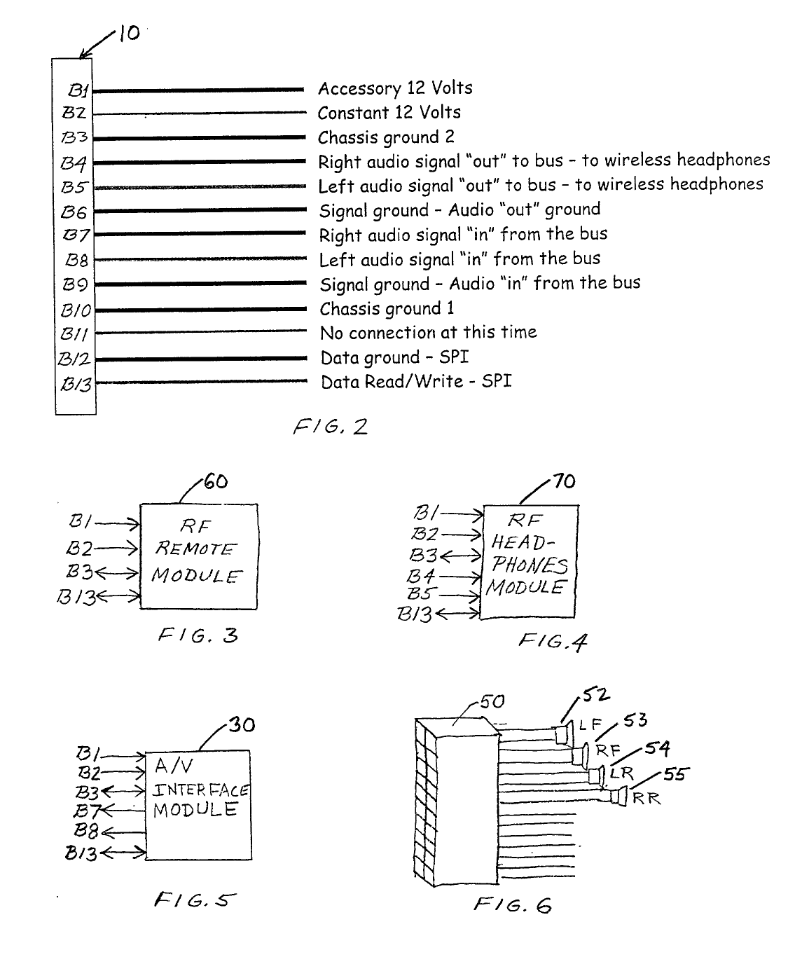

Referring to FIG. 3, the RF remote module 60 taps into the power and ground connections B1-B3 as well as the data read/write lines B12, B13 (B12 is always present with B13 but has been omitted for simplicity). Audio in/out lines B4-B9 are not necessary insofar as this is basically a command module having a receiver which receives digital RF signals from RF remote unit 65 (FIG. 12).

Referring to FIG. 4, the RF headphones module 70 taps into the power and ground connections B1-B3, the data read/write lines B12, B13, and the audio signal out lines B4-B6 (B6 has been omitted for simplicity). The module 70 includes a transmitter which transmits RF signals to a receiver in the headphones 75 (FIG. 13).

Referring to FIG. 5, the A/V interface module 30 taps into the power and ground connections B1-B3, the data read/write lines B12, B13, and the audio signal in lines B7-B9 (B9 omitted for simplicity). This permits the audio signals from the selected video source to be played over the front and/or rear speakers.

FIG. 6 shows the plug 50 which provides positive and negative signal wires for each of the front and rear speakers 52, 53, 54, 55. The plug also has connections for the battery, ground, ignition, and power antenna, and may be connected to an adaptor plug which attaches to the car's wiring harness.

FIG. 7 shows the A/V interface module 30 with first and second plugs 32, 33 for the bus. The first interface plug 34 mates with the second interface plug 36 on the adaptor harness 35, which carries the left and right audio lines from the RCA plugs 37, 38, as well as the data read/write and data ground lines to the control plug 39. The plugs 37, 38, 39 mate with complementary ports in the front of source selector module 40, a staple A/V switching unit e.g. a model BF-2000 of Hexa-Chain, Co., Ltd. Referring also to FIG. 8, each set of ports L1, R1, V1 etc. receives the audio and video inputs of an A/V source such as VCR 44 (FIG. 1), and outputs the video signals to monitor 42 via one of the ports V1, V2, V3. The audio signals from L1, R1 etc. are transmitted through the audio plugs 37, 38 and are picked by audio “in” lines B7, B8 on the bus for amplification in the head unit and transmission to the front and/or rear speakers via main plug 50, or to the headphones 75 via the audio “out” lines B4, B5 and headphones module 70.

FIG. 9 is a highly schematic rendition of the circuitry in the head unit, showing only the integrated circuits (IC's) without the associated interconnections and interfaces to the outside. Proceeding from the upper left, the there are two IC's for the tuner, which IC's process the antenna signals for the chosen band (AM or FM). The CDC IC processes signals from either the CD player in the head unit or the CDC unit 15, and the auxiliary IC processes the input from the auxiliary audio source 13 such as a tape deck or MP3 player. There are three IC's associated with audio signals on the bus; one for processing incoming signals from the selected A/V source 44, 46, 48, one for switching between audio input and output, and one for processing audio signals transmitted to the headphones module 70. There is a preamplifier circuit for each pair of speakers (front and rear), and an associated voltage inverter circuit. The speaker signals may be further amplified by an internal amplifier (shown at lower right), or be transmitted to an external amplifier for the more decibel-oriented audiophile.

The master microprocessor performs all of the system selection functions as may be selected by the manual and remote controls, and sends and receives signals to the various peripherals in clocked time slots. It also polls the system to see what peripheral modules have been installed and their status. Each of the modules has a slave microprocessor which provides this information. Finally, the display driver IC controls all of the indicia which appear on the head unit display.

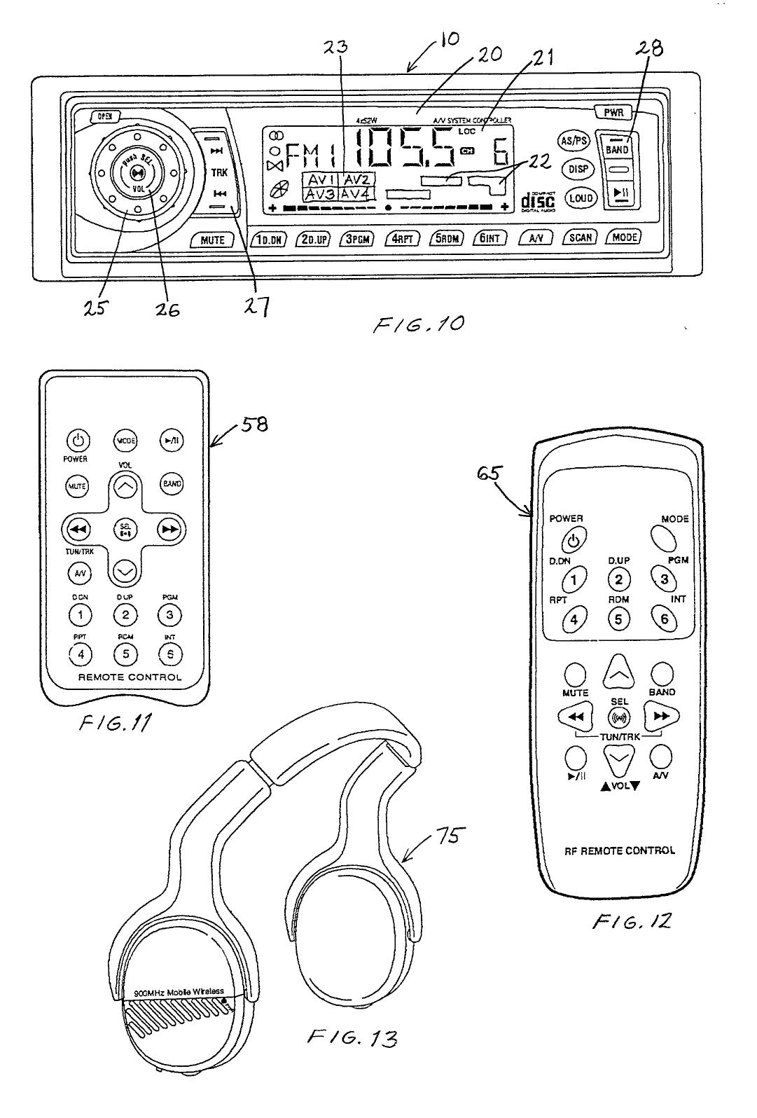

Referring to FIG. 10, the display panel 20 is hinged to the head unit 10, and can swing down in known fashion to receive a CD for playing in the head unit. The plate 20 includes an LCD 21 which provides the driver with status information including mode selected, frequency or track, active modules (22), selected A/V source (23), and the time. A rotary volume control 25, central select button 26, track button 27, and band button 28 are operated as described below to control the system.

The infrared remote control unit 58 shown in FIG. 11 operates to duplicate many of the functions of the manual controls, and may also be configured for mounting on the steering wheel. The unit 58 transmits infrared analog signals which are received by the head unit, and is therefore somewhat directional. The RF remote control unit 65 shown in FIG. 12 transmits digital RF signals which are received by the RF remote module 60, and is not directional. The headphones 75 (FIG. 13) receive RF signals transmitted by the headphones module 70, and are likewise not directional.

### System Operation

The system may be turned on by pressing any button on the display panel, and is turned off by pushing the power button. The loudness and mute buttons operate conventionally, but the volume knob is a rotary encoder which also controls other functions. Pressing the select button moves the unit through the volume, treble, bass, balance, and fade functions, which are indicated in the display. The volume knob is used to adjust the selected function. Pressing the mode button moves the unit through the tuner, CD player, CDC, A/V source selector, and auxiliary modes. If the selected module is not connected to the head unit, for example the auxiliary unit, it will not appear in the display. Pressing the display button causes the time display to blink, whereupon the time can be adjusted. The display button and the track button are also used to sequence the user through different CD time modes.

When the tuner mode has been selected, pressing the band button 28 changes the radio between three FM bands and two AM bands; each band stores up to six preset stations. Pressing the track button 27 up or down for less than two seconds causes the radio frequency to move up or down one step; pressing the button for over two seconds causes the tuner to seek the next station. Pressing the scan button causes the tuner to pause at each station for five seconds, and pressing it again causes it to stop at the station being played. A selected station may be stored as a preset by pressing one of the six preset buttons for two seconds; the preset station number appears on the display when the station is stored. A station in a selected band may be recalled by pressing one of the preset buttons for less than two seconds. Pressing the AS/PS button for more than two seconds causes the six strongest stations in the selected band to be stored. Pressing AS/PS for less than two seconds causes the stored stations to be scanned, and pressing it again causes the scanning to stop.

The mode automatically advances to CD when a CD is inserted, and can also be switched using the mode button. Pressing the top or bottom of the track button advances to the next or previous track, and holding the tracks button puts the CD into fast forward or reverse. The CD can be paused by pressing the bottom of the band button. The program buttons for the radio tuner also serve functions for the CD player including intro (INT) which previews all tracks, random (RDM) which plays all tracks in random order one time, repeat (RPT), and program (PGM) which is used with the track button to program up to 24 tracks into memory. The CDC mode operates similarly, but includes the options of selecting a disc by pressing the program buttons marked D.DN or D.UP. In the A/V mode, the A/V source can be selected by pushing the A/V button.

The IR remote unit 58 depicted in FIG. 11 also has a select button to select the functions VOL> TRE> BAS> BAL> FAD, a volume rocker, a tuning rocker, a band select for AM or FM, a CD pause/play button (upper right), and program buttons for the tuner, which once again double as function buttons for the CD.

The RF remote depicted in FIG. 12 (unlike the IR remote) can operate the system from anywhere in or near the vehicle since it is not limited to line of sight with the head unit. Its operation is similar to that of the head unit and IR remote already described, and may be used to control any of the tuner bands, the CD, the auxiliary input, the CDC, or the A/V inputs, except where such control conflicts with the inputs at the head unit. For example, where the driver is listening to a CD in the head unit, the rear seat occupants could control any of the A/V inputs, but could not interfere with the driver's enjoyment of the CD.

Further details of the system design and operation are within the skill of the art and therefore have not been elaborated. What has been described is exemplary and not intended to limit the scope of the claims which follow.

1. A multiple media system comprising
a head unit comprising a radio tuner, at least one of a cassette player and a CD player, a display, manual controls, a front amplifier, a rear amplifier, and a master microprocessor,
a pair of front speakers connected to said front amplifier,
a pair of rear speakers connected to said rear amplifier,
a bus connected to said master microprocessor and comprising at least one power line, at least one ground line, left and right audio signal out lines, left and right audio signal in lines, and a data read/write line, said bus extending from said head unit in a cable ending at a plug, and
at least one module connected to said head unit by said cable, said bus extending through each said module via a pair of opposed plugs, each said plug of each said module being mateable with one of said plugs of a further said module, one of said plugs of each said module being mateable with said plug on said cable.

2. A system as in claim 1 wherein said at least one module is a remote control module having a receiver, said system further comprising a remote control unit having a transmitter which transmits signals to said receiver, said receiver in turn transmitting signals to said head unit via said bus.

3. A system as in claim 2 wherein said receiver is an RF receiver and said transmitter is an RF transmitter.

4. A system as in claim 1 wherein said at least one module is a headphones module which receives audio signals from the head unit via the audio out lines in the interface bus, said system further comprising a pair of headphones which receive the audio signals from the headphones module.

5. A system as in claim 4 wherein said headphones module comprises an RF transmitter and the headphones are wireless headphones which comprise an RF receiver.

6. A system as in claim 1 wherein said at least one module comprises an audio/video interface module which is connectable to an audio/video source.

7. A system as in claim 6 further comprising at least one audio/video source which is connected to said interface module and thereby subject to control by said head unit via said bus.

8. A system as in claim 7 further comprising a source selector module connected between said interface module and said at least one audio/video source, and a TV/monitor connected to said source selector module.

9. A system as in claim 7 wherein said at least one audio/video source comprises at least one of a VCR, a DVD, a TV tuner, and a game station.

10. A system as in claim 1 wherein said microprocessor polls the bus upon system start up to detect what modules are installed and configures the system accordingly.

11. A system as in claim 10 wherein the installed modules are indicated on the display.

12. A system as in claim 1 wherein said head unit further comprises an auxiliary audio input.

13. A system as in claim 12 further comprising an auxiliary audio source connected to said auxiliary audio input, which source provides signals which can be amplified in the head unit and made available on the bus.

14. A system as in claim 1 wherein said head unit further comprises a CDC input for a compact disc changer.

15. A system as in claim 14 further comprising a compact disc changer connected to said CDC input, which compact disc changer provides signals which can be amplified in the head unit and made available on the bus.
